(19) United States
(12) Patent Application Publication
(10) Pub. No.: US 2011/0231395 A1
(43) Pub. Date: Sep. 22, 2011

(54) PRESENTING ANSWERS

(75) Inventors: VISWANATH VADLAMANI, REDMOND, WA (US); MUNIRATHNAM SRIKANTH, REDMOND, WA (US); PHANI VADDADI, ISSAQUAH, WA (US); TAREK NAJM, KIRKLAND, WA (US); ARUNGUNRAM CHANDRASEKARAN SURENDRAN, SAMMAMISH, WA (US)

(73) Assignee: MICROSOFT CORPORATION, Redmond, WA (US)

(21) Appl. No.: 12/727,836

(22) Filed: Mar. 19, 2010

(51) Int. Cl. G06F 17/30; G06T 11/20

(52) U.S. Cl. 707/723; 345/440; 707/769; 707/E17.014

(57) ABSTRACT

Systems, methods, and computer-storage media for presenting answers are provided. The system includes a search engine to receive user queries and contexts, a query understanding component to provide results, and an answer generator to present answers to the user queries. The answers may include a link to a browser that provides a graph, table, or cluster for the results, where nodes of the graph are associated with a confidence level.

### BACKGROUND

Conventional search engines receive queries from users and locate web pages having terms that match the terms included in the received queries. Conventionally, the search engines ignore the context and meaning of the user query and treat the query as a set of words. The terms included in the query are searched for based on frequency, and results that include the terms of the query are returned by the search engine.

Accordingly, conventional search engines return results that might fail to satisfy the interests of the user. The user attempts to reformulate the query by choosing words that are likely found in a document of interest. For instance, a user looking for stock information may enter a query for “PE Company A Stock.” The conventional search engine will treat each word separately and return documents having the term “Company A,” documents having the term “PE,” documents having the terms “stock,” and documents having any of the terms. The conventional search engine is unable to intelligently select documents in results that discuss the stock performance of Company A, a comparison of Company A to its competitor, and news about the management of Company A. The user must read the different documents in the results to determine whether any of the documents include performance information.

The results may not include answers to the query. “PE Company A Stock” is a query that may be answered with a discrete answer. The conventional search engines fail to provide discrete answers. Instead, the conventional search engines only return a collection of documents that include the terms of the query. Without a discrete answer, a user spends time perusing the results of the query to locate the answer.

### SUMMARY

Embodiments of the invention relate to systems, methods, and computer-readable media for presenting answers to user queries. The answers include discrete segments of information that may provide a user with the ability to quickly decide a course of action. The answers may reduce the length of time a user spends perusing results of the query.

A search engine receives a query from a client device along with context information provided by applications utilized during a current search session. In turn, a query understanding component processes the context information and query to issue data source commands to data sources that return answers and results to the search engine in response to the user query. The answers and results are presented to the user in an appropriate format based on the context information or a user selection.

This summary is provided to introduce a selection of concepts in a simplified form that are further described below in the detailed description. This summary is not intended to identify key features or essential features of the claimed subject matter, nor is it intended to be used as an aid in isolation to determine the scope of the claimed subject matter.

### BRIEF DESCRIPTION OF THE DRAWINGS

Illustrative embodiments of the invention are described in detail below with reference to the attached drawing figures, which are incorporated by reference herein, wherein:

FIG. 1 is a block diagram illustrating an exemplary computing device in accordance with embodiments of the invention;

FIG. 2 is a network diagram illustrating exemplary components of a computer system configured to present answers in accordance with embodiments of the invention;

FIG. 3 is a screenshot illustrating a graphical user interface displaying answers and results in accordance with embodiments of the invention;

FIG. 4 is a screenshot illustrating an entity browser in accordance with embodiments of the invention; and

FIG. 5 is a logic diagram illustrating a computer-implemented method for presenting answers in accordance with embodiments of the invention.

### DETAILED DESCRIPTION

This patent describes the subject matter for patenting with specificity to satisfy statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various steps herein described unless and except when the order of individual steps is explicitly described.

As used herein the term “component” refers to any combination of hardware, firmware, and software.

Embodiments of the invention provide answers to queries received by a search engine. The search engine is communicatively connected to a query understanding component and an answer generator. The search engine presents the answers and results to a user that issued the query. The answers are collected from a large collection of content having structured data, semistructured data, and unstructured data. The query understanding component parses the query to determine whether the query requires a discrete answer. In turn, the query understanding component may receive the results. The results are processed by the answer generator to select discrete answers in response to the user query. For instance, the query may be parsed by the query understanding component for interrogatives, e.g., who, what, where, when, how, etc. The answer generator may be configured to select discrete answers for queries that include interrogatives. In certain embodiments, the answer generator formats the answers in one of a table, graph, or cluster. The answer generator may use an ontology to generate the answers and to identify entities that are associated with the answers and documents that are included in the results. The answers may include navigable icons or links to the entities or the documents. In an embodiment, the answers include a confidence level based on statistical information corresponding to documents identified by the answers or a source that provided the documents.

For instance, a search engine may return results and answers to a query for stock ratios. The answers for a user's finance queries are returned by the search engine using an ontology to respond to a query that includes an interrogative for stocks. The search engine may receive a natural language query like “What is the PE ratio for Company A.” The search engine parses the query and identifies the interrogative. The search engine also receives results from data sources that are searched based on the query. The answer generator may process the results and use an ontology to generate or identify answers for the query. The answers and results are returned to the search engine for display to the user that issued the query.

The search engine receives queries from a user. Also, the search engine receives contexts for one or more applications that provide the queries during the current search session. Data sources are searched to locate results that respond to the queries. The results are further processed by the answer generator to identify answers for the queries. The answers may be presented in a graphical user interface as a graph, table, cluster, etc. In one embodiment, the search engine receives both a discrete answer and results from the answer generator in response to the user query.

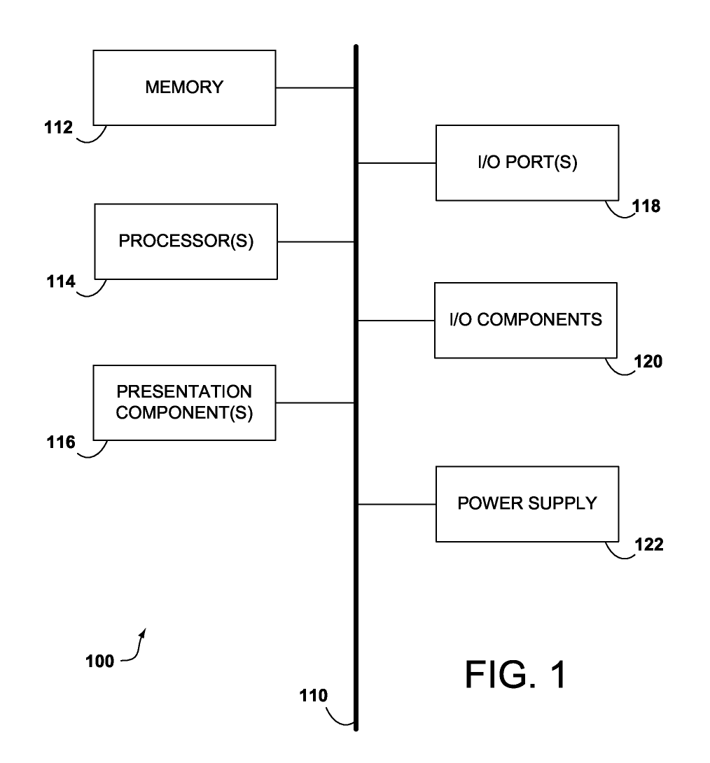

FIG. 1 is a block diagram illustrating an exemplary computing device in accordance with embodiments of the invention. The computing device 100 includes bus 110, memory 112, processors 114, presentation components 116, input/output (I/O) ports 118, input/output (I/O) components 120, and a power supply 122. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that may be used to encode desired information and be accessed by the computing device 100. Embodiments of the invention may be implemented using computer code or machine-useable instructions, including computer-executable instructions such as program modules, being executed by a computing device 100, such as a personal data assistant or other handheld device. Generally, program modules including routines, programs, objects, modules, data structures, and the like, refer to code that performs particular tasks or implements particular abstract data types. Embodiments of the invention may be practiced in a variety of system configurations, including distributed computing environments where tasks are performed by remote-processing devices that are linked through a communications network.

The computing device 100 includes a bus 110 that directly or indirectly couples the following components: a memory 112, one or more processors 114, one or more presentation modules 116, input/output (I/O) ports 118, I/O components 120, and an illustrative power supply 122. The bus 110 represents what may be one or more busses (such as an address bus, data bus, or combination thereof). Although the various components of FIG. 1 are shown with lines for the sake of clarity, in reality, delineating various modules is not so clear, and metaphorically, the lines would more accurately be grey and fuzzy. For example, one may consider a presentation component 116 such as a display device to be an I/O component. Also, processors 114 have memory 112. Distinction is not made between “workstation,” “server,” “laptop,” “handheld device,” etc., as all are contemplated within the scope of FIG. 1.

The memory 112 includes computer-readable media and computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors 114 that read data from various entities such as the memory 112 or I/O components 120. The presentation components 116 present data indications to a user or other device. Exemplary presentation components 116 include a display device, speaker, printer, vibrating module, and the like. The I/O ports 118 allow the computing device 100 to be physically and logically coupled to other devices including the I/O components 120, some of which may be built in. Illustrative I/O components 120 include a microphone, joystick, game pad, satellite dish, scanner, printer, wireless device, and the like.

A computer system presents answers and results in response to queries. The computer system includes a search engine, client devices, a query understanding component, data sources, and an answer generator. The client devices issue the queries to the search engine. The queries are sent to the query understanding component from the search engine. In certain embodiments, the search engine may also receive a context from the client devices. In turn, the query understanding component parses the queries and issues data source commands to identify results in the data sources that respond to the queries. The results are further processed by the answer generator to select discrete answers for the query. The search engine receives the results and answers from the answer generator and transmits both the results and answers to the client device for display to the user.

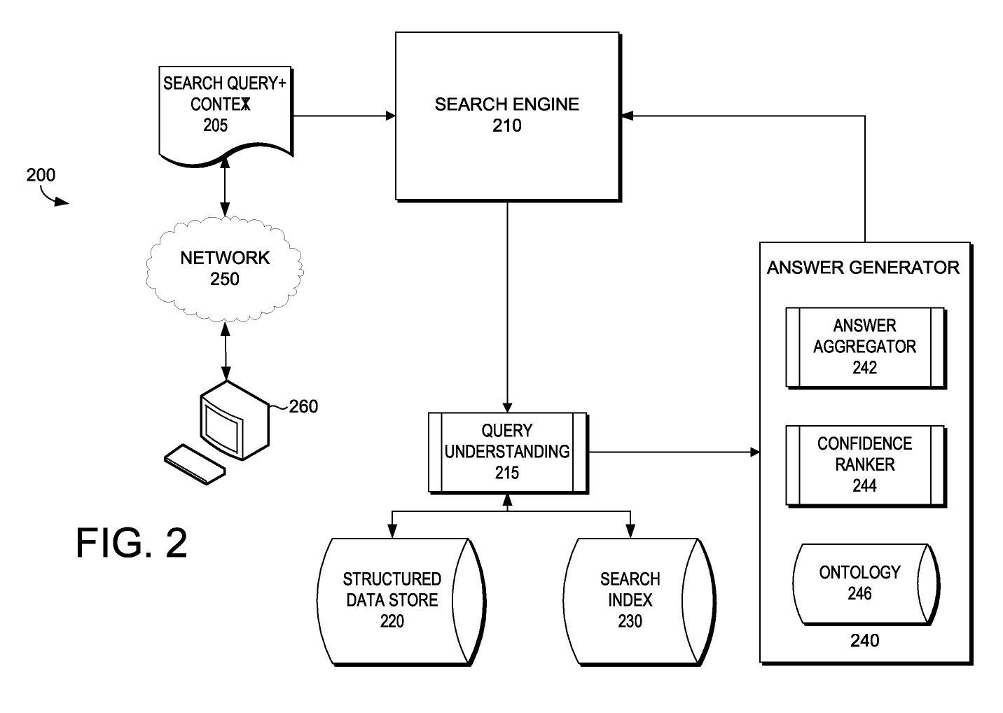

FIG. 2 is a network diagram illustrating exemplary components of a computer system 200 configured to present answers in accordance with embodiments of the invention. The computer system 200 includes a search engine 210, structured data sources 220, search index 230, answer generator 240, network 250, and client device 260.

The search engine 210 is a server computer that provides results for queries received from client device 260. The results are retrieved from the structured data source 220 or the search index 230. The search engine 210 also provides answers selected from the results. The search engine 210 is configured to receive queries and contexts from the client device 260. The queries include the terms selected by a user and the contexts provide information about the application used by the user when generating the query. The contexts may include display formats, screen size limits, and other information about the application or the client device 260. The search engine 210 returns results and answers in response to the queries. In some embodiments, the search engine 210 returns only answers to the queries.

The query understanding component 215 is configured to parse the query and to select sources that are traversed to locate results. In certain embodiments, the sources include, among others, structure data sources 220 and search index 230. The query understanding component 215 is configured to generate a semantic representation of the query and context. The semantic representation is used to select sources and to issue commands that cause the sources to provide results. The commands may include structure query language (SQL) or semantic query representation (SQR) commands. The SQR may include: query type (QT), Context (CXT), and Display (DSP) templates. For instance, a natural language query for Company A may have the following SQR <QT: Instance Profile: Company; Instance Type: Stock; Instance URI: Company A> <CXT: Natural Language, Finance> <DSP: Company Name, Symbol, News>. QT is a formal representation of a hierarchy of the different types of queries an application can expect from its users. CXT is a formal representation of a hierarchy of the different types of contexts in which the user query can be captured and interpreted. CXT can be explicitly identified by the applications a user interacts with to issue their queries or implicitly derived from the query text. Each CXT identifies the conditions and criteria for interpreting concepts, instances, etc. in a given query. The CXT may either expand or disambiguate the concepts, instances, etc., included in the semantic query representation. DSP identifies the display format expected by the client device 260 and includes display formats available for the results that match the query. In turn, the results returned from the sources are processed by the answer generator 240 to select answers that respond to the queries.

The structured data sources 220 store information and metadata describing the stored information. The structured data sources 220 include, but are not limited to, databases, tables, markup language pages, etc. The structured data sources 220 may be domain-specific, e.g., health, finance, electronics, etc. The structured data sources 220 may be searched for terms that match the query received by the search engine 210. In certain embodiments, the query understanding component 215 selects one or more structured data sources that are searched for the results in response to the query.

The search index 230 stores documents that are crawled by the search engine 210. The documents include, images, text, video, etc. The documents are referenced in the search index 230 along with terms included in the documents. The search index 230 is utilized by the search engine 210 to provide additional results that match terms included in the queries received from the client device 260.

The answer generator 240 receives the results from the sources, including structured data sources 220 and search index 230. In one embodiment, the answer generator 240 also obtains a context received from the search engine 210. The context provides instructions for displaying the answers. The instructions may include an indication of the number of answers, the font size of the answers, and the structure for the answers. The structure for the answers may include, but is not limited to, list, graph, table, etc. The context may be provided, by the client device 260, to the search engine 210, which transmits the context to the answer aggregator 240 via the query understanding component 215. The answer generator 240 may utilize the context to format the results presented by the search engine 210 for display by the client device 260.

The answer generator 240 selects answers from the received results. The answer generator 240 includes an answer aggregator 242, confidence ranker 244, and ontology 246. In an embodiment, answer generator 240 selects answers by utilizing the ontology 246 associated with a query provided by the client device 260, and the ontology 246 corresponding to applications—executed by the client device 260—that formulate the query. In turn, the search engine 210 transmits answers to the queries and results that include content corresponding to the query to the client device 260. The client device 260 displays the results along with the answers and allows a user to traverse the answers in a number of formats including, but not limited to, graph, table, cluster, list, etc.

The answer aggregator 242 collects the results from the sources. In some embodiments, the answer aggregator 242 periodically checks the sources for updates to the results. The answer aggregator 242 also formats selected results for display. For instance, the answer aggregator 242 may select several results that provide a discrete answer. In an embodiment, the answer aggregator 242 may search the results for interrogatives that include the terms of the query, and return a segment of the result that is near to the interrogative or a link to documents including the interrogative having the terms of the query.

The confidence ranker 244 may assign a score to each discrete answer selected by the answer aggregator 242. The score may range from 0 to 1 and vary based on the source the provides the results. The score is based on a statistical analysis of the sources. The statistical analysis may measure the amount of time a user spends seeking for an answer to a question and the number of query formulations used to locate the answer. In some embodiments, the score assigned to a result is closer to 1 if previous users clicked or hovered on the result after a low number of query formulations and within a small length of time. In one embodiment, multilevel thresholds may be configured in the confidence ranker 244. When the number of query formulations is less than 5 and previous users clicked or hovered on the result within 3 seconds, the confidence ranker 244 assigns a score that ranges between 0.8 and 1. When the number of query formulations is between 5 and 10, and previous users clicked or hovered on the result within 5 seconds, the confidence ranker 244 assigns a score that ranges between 0.5 and 0.7. When the number of query formulations is between 10 and 15, and previous users clicked or hovered on the result within 10 seconds, the confidence ranker 244 assigns a score that ranges between 0 and 0.5. In an alternative embodiment, the results from the structured data source 220 may be assigned higher scores than results from the search index 230.

The ontology 246 stores rules and definitions for phrases and concepts. The ontology 246 also stores relationships among the phrases and concepts. The ontology 246 includes words or phrases that correspond to content in the sources. Each ontology 246 includes a taxonomy for a domain and the relationship between words or phrases in the domain. The domains may include medicine, art, computers, etc. In one embodiment, the ontology 246 also stores the query type and context type. The query type identifies the type and structure of textual user queries. For instance, the query type may include natural language, structured, in-line command, etc. The context type identifies and organizes the different types of contexts in which queries can be expressed. For instance, the context may include search engine, email application, finance application, etc. The rules identify the concepts, instances, properties, and relations across a number of domains. In certain embodiments, the rules may define methods or functions that are used to compute results from data included in the data sources. For instance, the rules may include comparators, mathematical functions, statistical functions, or other heuristics.

The ontology 246 is used by the answer aggregator 242 to identify related answers and to group the answers based on the definitions or concepts included in the ontology 246. The ontology 246 may be used to generate the lists, table, cluster, graphs, etc., for the answers. In some embodiments, the answer generator 240 provides several answers to the search engine 210, which forwards the answers over network 250 to client device 260. The answer generator 240 may use the context received from the client device 260 to format the answers. In one embodiment, the answer is formatted as a graph that includes nodes. The node in the graph is associated with a score based on the statistical analysis of the data sources. The node also includes the answer and a concept, related the answer, selected from the ontology 246. Optionally, the node may include a uniform resource indicator to an underlying document that provided the answer. The nodes in the graph are connected via edges. The edges represent relationships between answers. The relationship may include “is a,” “contains,” “type of,” “similar to,” etc. The graph can be traversed by the client device 260. The graph may be presented graphically on the client device 260 in a browser, and the nodes may be traversed to obtain an overview of the answers to the user query. In one embodiment, the nodes may represent an entity.

The network 250 connects the client device 260 and search engine 210. The network 250 may be wired, wireless, or both. The network 250 may include multiple networks, or a network of networks. For example, the network 250 may include one or more wide area networks (WANs), one or more local area networks (LANs), one or more public networks, such as the Internet, or one or more private networks. In a wireless network, components such as a base station, a communications tower, or even access points (as well as other components) may provide wireless connectivity in some embodiments. Although single components are illustrated for the sake of clarity, one skilled in the art will appreciate that the network 250 may enable communication between any number of client devices 260.

The client device 260 is connected to the search engine 210 via network 250. In some embodiments, the client device 260 may be any computing device that is capable of web accessibility. As such, the client device 260 might take on a variety of forms, such as a personal computer (PC), a laptop computer, a mobile phone, a personal digital assistance (PDA), a server, a CD player, an MP3 player, a video player, a handheld communications device, a workstation, any combination of these delineated devices, or any other device that is capable of web accessibility.

The client device 260 allows a user to enter queries. The client device 260 transmits the queries to the search engine 210. In certain embodiments, the client device 260 also transmits a context associated with an application used by the user to formulate the query. In other embodiments, the search engine 210 may provide the context. In turn, the client device 260 receives results that include answers. The client device 260 may also display the answers and results. The display may include any one of a graph, list, table, etc. The context provided to the search engine 210 may include instructions on the display format, display size, font size, etc.

In an embodiment, answers are transmitted to a client device with results. The answers and results are displayed by the client device. The display is a graphical user interface having a result portion and an answer portion. The user may interact with answers and results by using a pointer device to hover over, or select, the answers and results.

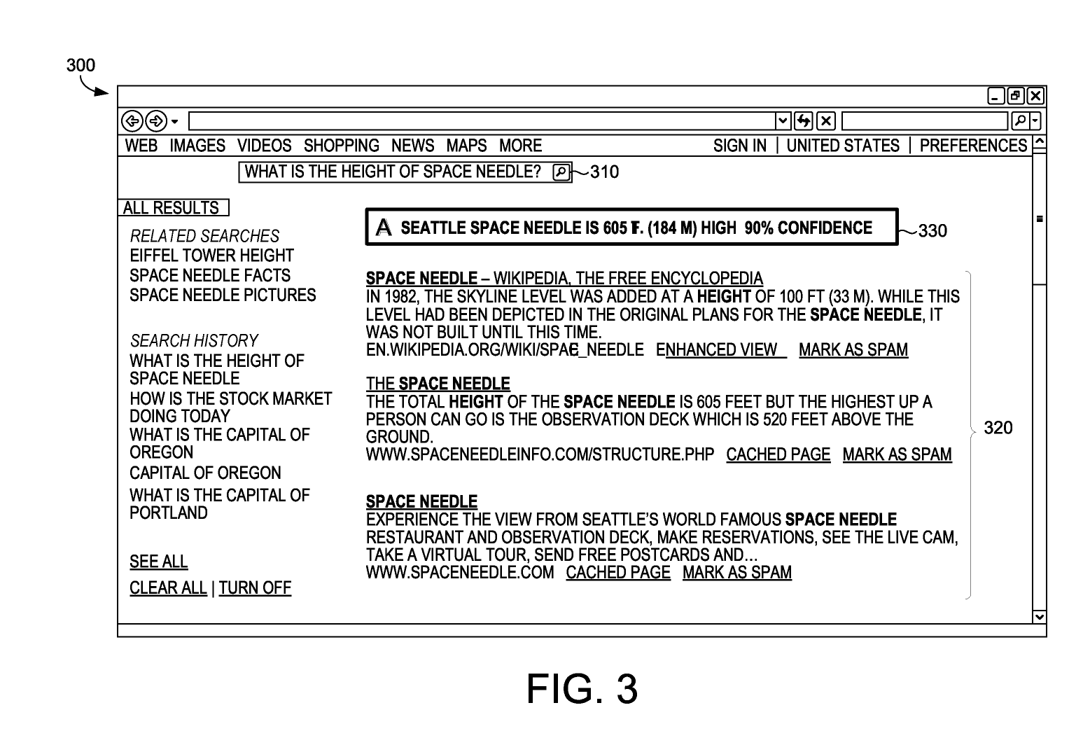

FIG. 3 is a screenshot illustrating a graphical user interface 300 displaying answers and results in accordance with embodiments of the invention. The graphical user interface 300 includes a search box 310, a results portion 320, and an answer portion 330.

The search box 310 is a text field that receives input from the client device. The input includes terms, phrases that express an inquiry. For instance, the search box 310 may receive “What is the height of the Space Needle.” The client device initiates the search and sends the query to a search engine. In some embodiments, the search engine also receives a context from the client device.

The search engine processes the inquiry and locates answers and results for the query. The answers and results are returned to the client device. The graphical user interface 300 is updated to display the answers and results in the answer portion 330 and result portion 320.

The result portion 320 is configured to display the results from the sources. The results include a link to the document including terms included in the query. The result portion 320 displays a limited number of results on several pages. The result portion 320 only include results that include one or more of the query terms.

The answer portion 330 is configured to display one answer selected from the results. The answer portion 330 also displays a score representing a confidence in the answer. In an embodiment, the answer portion 330 provides a link that allows the user to access an entity browser that provides a view having the document that provided the answers and a graphical summary of the results, related concepts, and related documents. The view may include a table, list, graph, etc. The view may be formatted based on the context information provided by the client device.

In another embodiment, the client device displays the entity browser to the user. The entity browser may include a discrete answer to the query and a summary of the answers and results. In turn, the user may navigate the entity browser to locate related concepts or additional answers to the query.

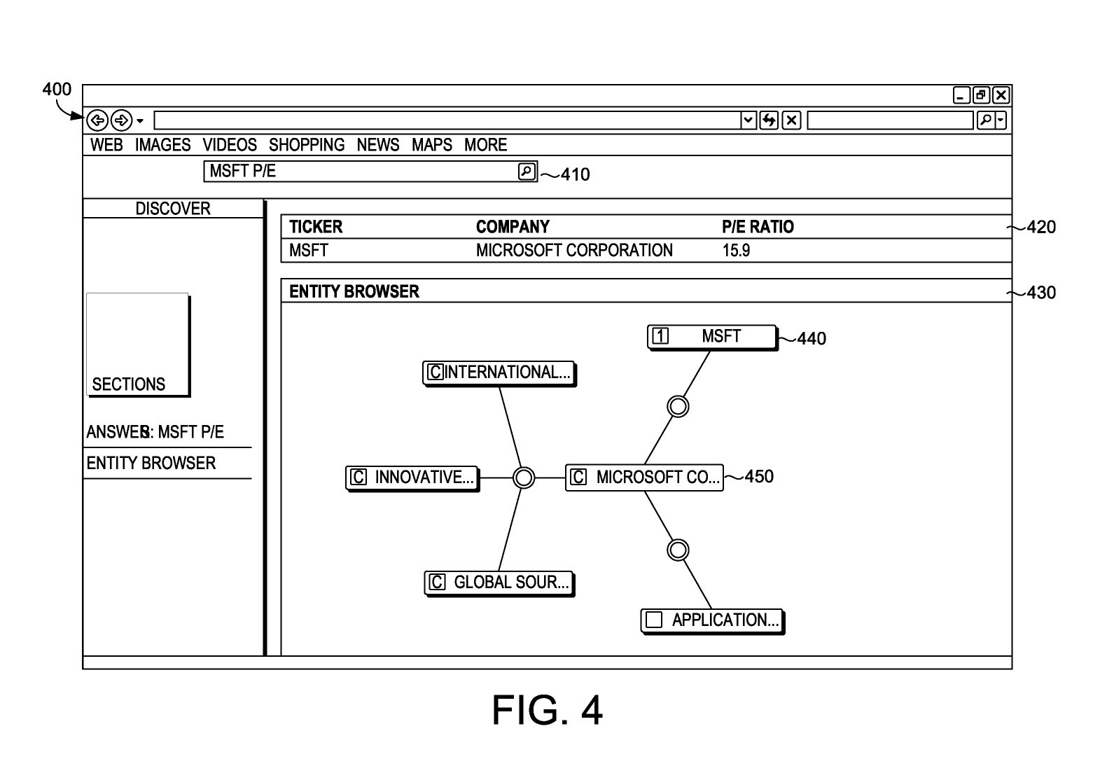

FIG. 4 is a screenshot illustrating an entity browser 400 in accordance with embodiments of the invention. The entity browser 400 includes a discrete answer section 420 and a summary section 430. The entity browser 400 allows a user to graphically view a summary of the answers and results as a graph, list, cluster, etc.

The discrete answer section 420 includes an answer to the query. The discrete answer section 420 displays structured information or metadata that describes the displayed answer. For instance, a query “MSFT PE” may include answers such as “15.9.” The discrete answer section 420 displays the metadata attributes: “Ticker,” “Company,” and “P/E ratio” with the values for those metadata attributes, “MSFT,” “Microsoft,” and “15.9,” respectively.

Summary section 430 includes a formatted list, graph, or table that summarizes the answers, results, and related documents. In one embodiment, the summary section 430 may display a graph having nodes 440 and 450. The nodes 440 or 450 represent a concept associated with the answer. The node 440 or 450 also includes a link to documents having terms included in the query. A user may click on the node 440 or 450 to retrieve the document and other related items, e.g., news articles, images, videos, graphs, etc. The edges connecting the nodes identify the relationship between two nodes. A user may click on the edge to view additional results having a similar relationship. In one embodiment, clicking on the edge issues a subsequent query using the definition for the relationship as the query. Accordingly, the summary section 430 is navigated by clicking on the nodes or edges to view the related answers and results.

The search engine is configured to present the answers. The search engine includes computer-readable media storing instructions that are executed by a processor. The processor in the search engine receives a query and identifies results associated with the query. In turn, the results are transmitted to a client device along with answers to the query for display to a user of the client device.

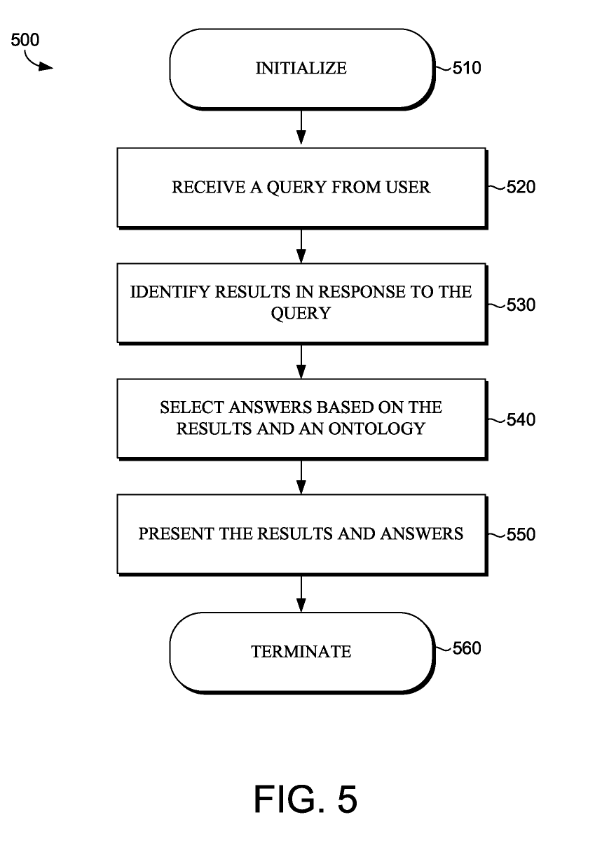

FIG. 5 is a logic diagram illustrating a computer-implemented method for presenting answers in accordance with embodiments of the invention. The method initializes in step 510 when the search engine is connected to a network of client devices. In step 520, the search engine receives a user query. In step 530, the search engine identifies results that respond to the user query. In turn, answers are selected, by the search engine, based on the results and an ontology, in step 540. The answers are associated with a confidence level, and the ontology describes relationships associated with terms included in the user query. In one embodiment, the answers may link to a browser for traversing relationships associated with answers. The relationships may represent entities in the ontology associated with the user query, and the links include navigable icons for related entities or documents associated with the entities.

In step 550, the identified results and the selected answers are presented for display to the user. In one embodiment, the answers comprise phrases included in the ontology and navigable links to documents in the results. Presenting the identified results and the answers by search engine includes any of the following: displaying the answers in a table on a client device, displaying the answers in clusters on the client device, or displaying the answers in a graph having a network of nodes on the client device. In step 560, the method terminates.

In summary, answers and results are presented by a computer system. The computer system includes a query understanding component and an answer generator. The query understanding component is configured to receive a query and parse the query to generate appropriate data source commands that are issued against data sources to obtain results. The answer generator is configured to present answers and the results to the user of the computer system. The answers may include a link to a browser that provides a graph, table, or cluster for the results, where nodes of the graph are associated with a confidence level.

Many different arrangements of the various components depicted, as well as components not shown, are possible without departing from the spirit and scope of the present invention. Embodiments of the invention have been described with the intent to be illustrative rather than restrictive. It is understood that certain features and subcombinations are of utility and may be employed without reference to other features and subcombinations and are contemplated within the scope of the claims. Not all steps listed in the various figures need be carried out in the specific order described.

The invention claimed is:

1. A computer-implemented method to present answers to a user query, the method comprising:
receiving a user query;
identifying results that respond to the user query;
selecting answers based on the results and an ontology; and
presenting the identified results and the selected answers for display to the user.

2. The method of claim 1, wherein the ontology describes relationships associated with terms included in the user query.

3. The method of claim 1, wherein the answers comprise phrases included in the ontology and navigable links to documents in the results.

4. The method of claim 3, wherein presenting the identified results and the answers includes displaying the answers in a table.

5. The method of claim 3, wherein presenting the identified results and the answers includes displaying the answers in clusters.

6. The method of claim 3, wherein presenting the identified results and the answers includes displaying the answers in a graph having a network of nodes.

7. The method of claim 1, wherein the answers are associated with a confidence level.

8. The method of claim 1, wherein the answers link to a browser for traversing relationships associated with answers.

9. The method of claim 8, wherein the relationships are entities in the ontology associated with the user query.

10. The method of claim 9, wherein the links are navigable icons for related entities or documents associated with the entities.

11. One or more computer readable media configured to perform a method to process queries, the method comprising:
receiving a user query;
identifying results that respond to the user query;
selecting answers based on the results and an ontology, wherein the ontology describes relationships associated with terms included in the user query; and
presenting the identified results and the selected answers for display to the user.

12. The method of claim 11, wherein the answers comprise phrases included in the ontology and navigable links to documents in the results.

13. The method of claim 12, wherein presenting the identified results and the answers includes displaying the answers in a table.

14. The method of claim 12, wherein presenting the identified results and the answers includes displaying the answers in clusters.

15. The method of claim 12, wherein presenting the identified results and the answers includes displaying the answers in a graph having a network of nodes.

16. The method of claim 11, wherein the answers are associated with a confidence level.

17. The method of claim 11, wherein the answers link to a browser for traversing relationships associated with answers.

18. The method of claim 17, wherein the relationships are entities in the ontology associated with the user query.

19. The method of claim 18, wherein the links are navigable icons for related entities or documents associated with the entities.

20. A computer system configured to present answers to a user query, the computer system comprising:
a query understanding component configured to receive a query and parse the query to generate appropriate data source commands that are issued against data sources to obtain results; and
an answer generator configured to present answers and the results, wherein the answers include a link to a browser that provides a graph, table, or cluster for the results, wherein nodes of the graph are associated with a confidence level.
